(19) United States
(12) Patent Application Publication
(10) Pub. No.: US 2018/0178256 A1
(43) Pub. Date: Jun. 28, 2018

(54) Marine Riser Cleaning and Inspection Process

(71) Applicant: Oceaneering International, Inc., Houston, TX (US)

(72) Inventor: Patrick J Donovan, Portsmouth, RI (US)

(73) Assignee: Oceaneering International, Inc., Houston, TX (US)

(21) Appl. No.: 15/852,949

(22) Filed: Dec. 22, 2017

Related U.S. Application Data
(60) Provisional application No. 62/437,826, filed on Dec. 22, 2016.

(51) Int. Cl. B08B 3/02; E21B 37/00; E21B 47/00; B08B 9/049; H04N 5/225

(52) U.S. Cl. CPC B08B 3/024; E21B 37/00; E21B 47/0001; G01N 29/07; B08B 9/0492; H04N 5/2256; E21B 47/0002

(57) ABSTRACT

A system to remove scale prior to well completion is inserted into a marine riser section, the system comprising a robotic crawler comprising a motive assembly sized to fit within an interior of the marine riser section and a predetermined set of attachments, operatively connected to the motive assembly, which are useful for conducting a predetermined set of marine riser interior cleaning and inspection operations while deployed within the marine riser. A first attachment of the predetermined set of attachments is used to clean an interior of the marine riser; at a first predetermined time, a second attachment of the predetermined set of attachments is used to perform a predetermined set of inspections of the interior of the marine riser section. At a second predetermined time, effluent resulting from the cleaning may be removed.

### RELATIONSHIP TO PRIOR APPLICATIONS

This application claims priority through U.S. Provisional Application 62/437,826 titled “Marine Riser Cleaning And Inspection Process” filed on 22 Dec. 2017.

### BACKGROUND OF THE INVENTION

Drilling risers are currently inspected by shipping the segments (joints) ashore every five years, removing the floatation surrounding the riser, and conducting tests such as manual non-destructive tests of welds, measurement of wall thickness, cleaning of interior surfaces, and visual inspection. This results in a very high cost to the owner due to transportation and handling. Further, the riser joints are often damaged in the inspection process due to the excessive wear and tear of the handling process.

### FIGURES

The figures supplied herein illustrate various embodiments of the invention. Items not expressly illustrated in the drawings are not necessary for the understanding of the subject matter sought to be patented by one of ordinary skill in these arts.

FIG. 1 is a first view in partial perspective of an exemplary robotic crawler;

FIG. 2 is a second view in partial perspective of an exemplary robotic crawler;

FIG. 3 is a view in partial perspective of an robotic crawler and its water cleaning lance;

FIG. 4 is a first view in partial perspective of an exemplary robotic crawler inside a marine riser section;

FIG. 5 is a second view in partial perspective of an exemplary robotic crawler inside a marine riser section;

FIG. 6 is a third view in partial perspective of an exemplary robotic crawler inside a marine riser section; and

FIG. 7 is a block schematic diagram of an exemplary system using an exemplary robotic crawler inside a marine riser section.

### DESCRIPTION OF EXEMPLARY EMBODIMENTS

Referring now to FIGS. 1-3, robotic crawler 1, which is useful to deliver tooling focused on cleaning and inspection of marine riser section 100 (FIG. 4), comprises motive assembly 10 sized to fit within an interior of marine riser section 100, and a predetermined set of attachments 20 (FIG. 4) operatively connected to motive assembly 10.

Motive assembly 10 is controllable to selectively traverse interior 101 (FIG. 4) of marine riser section 100 (FIG. 4). Typically, motive assembly 10 is operative to traverse interior 101 (FIG. 4) of marine riser section 100 (FIG. 4) where marine riser section 100 is in either a horizontal or a vertical orientation. In embodiments, motive assembly 10 comprises a plurality of tracked treads 11 adapted to engage interior 101 of marine riser 100. In embodiments, motive assembly 10 comprises selectively extendable and retractable portion 12 which may be operatively connected to tracked treads 11. Typically, three such tracked treads 11 are used. Controllable motor 13 (FIG. 4) is operatively in communication with tracked treads 11.

The predetermined set of attachments 20 are useful for conducting a predetermined set of marine riser interior cleaning and inspection operations while deployed within marine riser section 100. These predetermined set of operations may comprise cleaning and inspection of marine riser section 100 from interior 101 (FIG. 4) of marine riser section 100, which are often referred to as joints and are typically 100 ft sections. Most riser joints comprise a main riser, one or more choke and kill lines, one or more conduit lines, and one or more mud boost lines.

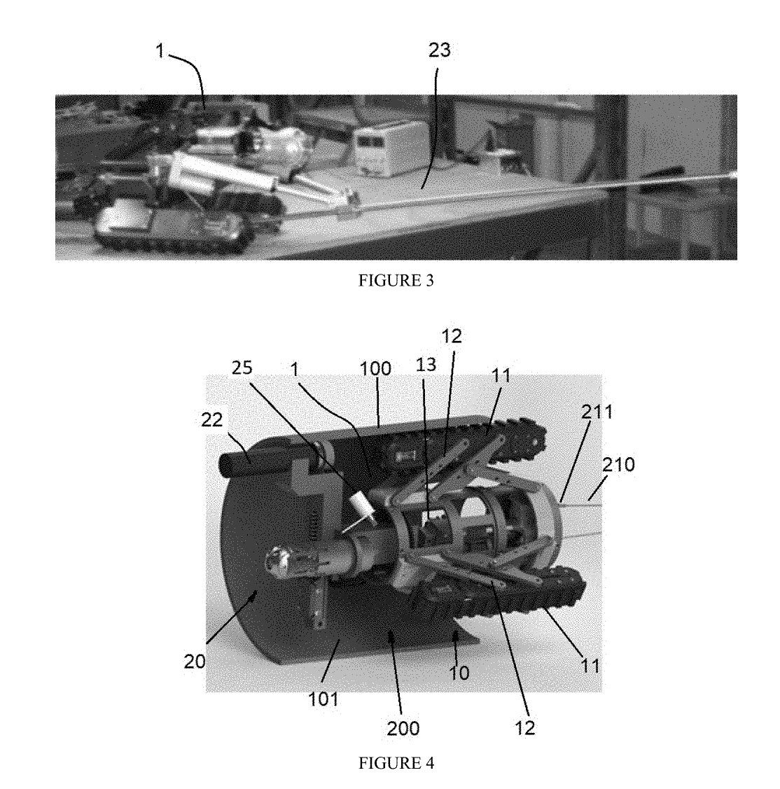

In embodiments, the predetermined set of attachments 20 (FIG. 4) comprises a predetermined set of ultrasonic and/or Time-Of-Flight (UT/Toft) tooling, alternating current field measurement (ACFM) tooling, water cleaning lance 23 (FIG. 3) which can comprise rotary and/or straight jetting nozzles, a predetermined set of non-destructive testing equipment, a high resolution camera or the like such as camera 25 (FIG. 4), or a combination thereof.

One or more auxiliary lights 24 may also be present.

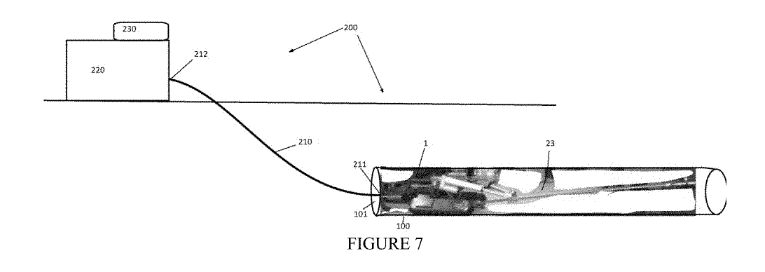

Referring now to FIG. 4, system 200, useful for cleaning and inspection of an interior of marine riser section 100, comprises robotic crawler 1, which is as described above; tether 210 operatively connected to robotic crawler 1 at first tether end 211 and to tether controller 220 (FIG. 7) at second tether end 212 (FIG. 7); and operation controller 230 (FIG. 7) operatively in communication with predetermined set of attachments 20.

In certain embodiments, tooling may be mounted on a tooling skid that integrates onto robotic crawler 1. The tooling skid may incorporate a plurality of ToFT sensors (not shown in the figures), e.g. a transmitter and a receiver; a plurality of shear wave transducer sets, e.g. two; a plurality of longitudinal wave transducers, e.g. four; a plurality of cameras useful to help position the tooling skid over welds, e.g. two; and a lubrication delivery system for probe heads. For auxiliary lines a single longitudinal wave transducer (not shown in the figures) may be fitted to a sensor cart (not shown in the figures) along with lubrication delivery.

In certain embodiments, a secondary skid may be deployed with an ACOUSTOCAM™ system and longitudinal wave transducers. This secondary skid may offer enhanced corrosion mapping alongside non-destructive testing (NDT) and thickness measurements.

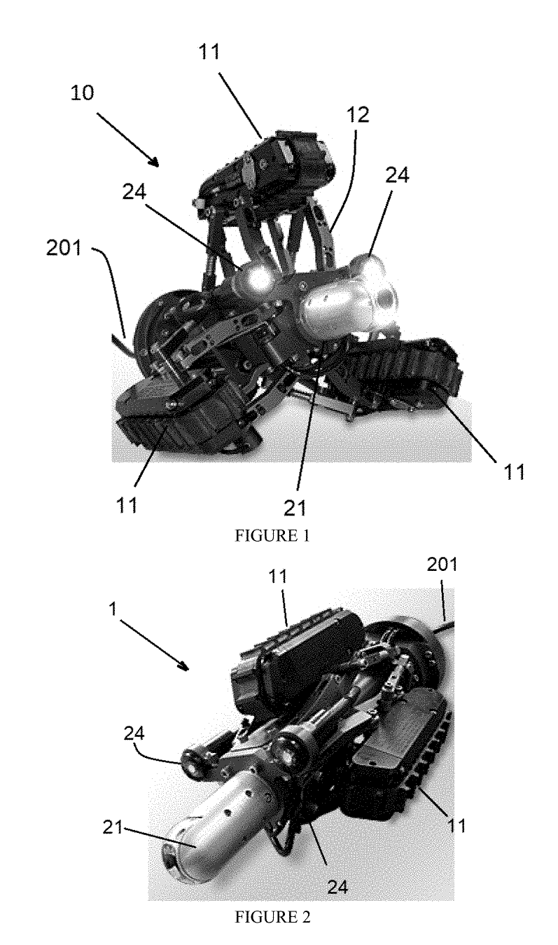

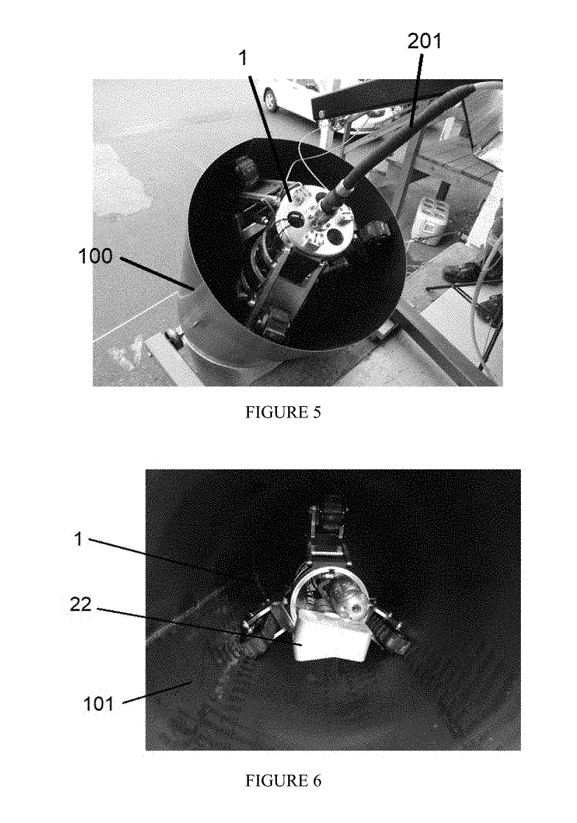

In the operation of exemplary embodiments, referring additionally to FIGS. 5-6, a system may be provided for the removal of an unwanted substance such as scale prior to well completion by inserting a jetting tool such as system 200 (FIG. 4) into marine riser section 100 (FIG. 4), where system 200 is as described above. First attachment 21 (FIG. 2) of the predetermined set of attachments 20 may be used to clean interior 101 of marine riser section 100.

At a first predetermined time, second attachment 22 (FIG. 4) of the predetermined set of attachments 20 may also be used to perform a predetermined set of inspections of interior 101 of marine riser section 100, without having to remove robotic crawler 1, such as while the riser is deployed in column connected to a subsea structure such as a blowout preventer (BOP) (not shown in the figures). The first predetermined time typically comprises a time substantially simultaneous with a time when system 200 is being used to clean interior 101 of marine riser section 100. In certain embodiments, the first predetermined time comprises a time after completion of cleaning and the predetermined set of inspections comprises using system 200 to conduct close visual inspection of the interior of the marine riser section. Accordingly, inspections may include using system 200 to inspect a predetermined portion of interior 101 of marine riser section 100 by using a visual inspection device, e.g. camera 25 (FIG. 2), to ensure that the cleaning was effective while system 200 is in marine riser section 100.

In other embodiments, the first predetermined time comprises a time after completion of cleaning and the predetermined set of inspections comprises using system 200 to record a wall thickness measurement of interior 101 of marine riser section 100, using system 200 to conduct a non-destructive test of a weld on a predetermined set of marine riser section 100, using system 200 for full length corrosion mapping and real time analysis in change detection, detecting a corrosion “hotspot” in surface coating and mapping the detected corrosion hotspot, or the like, or a combination thereof. Other inspection methods may be used, such as ToFD ultrasonic testing for defects in weld volume detection over the length of the weld, pule echo shear wave tests to detect detection in weld root and cap, pulse echo longitudinal wave tests used to determine pipeline thickness measurements, phased array ultrasonic testing, and the like, or a combination thereof.

Non-destructive tests may comprise determining a thickness measurement on a main line to be conducted from interior 101 of marine riser section 100 due to a flotation collar on an exterior of the main line.

In certain embodiments, data about the cleaning and/or inspection functions are gathered and the gathered data cataloged for use in viewing the data in a 3D model with information overlay.

A ToFT method may be used to allow weld inspection through an entire heat affected zone.

In addition, in embodiments a laser mapping may be created of interior 101 of marine riser section 100 and a laser mapping created of a well bore. A laser mapping may be created as well of a BOP to ensure that it is within a predefined range of physical tolerances.

In these various embodiments, conducting the inspection(s) may occur while marine riser section 100 contains seawater.

In certain embodiments, all effluent resulting from the cleaning may he recovered at a second predetermined time. By way of example and not limitation, a vacuum system (not shown in the drawings) may be used during cleaning to contain runoff during cleaning operations. The vacuum system may comprise a diesel/electric/air driven vacuum pump with a containment dome fitted to the riser that will recover effluent into storage tanks for disposal ashore.

The foregoing disclosure and description of the inventions are illustrative and explanatory. Various changes in the size, shape, and materials, as well as in the details of the illustrative construction and/or an illustrative method may be made without departing from the spirit of the invention

1. A robotic crawler useful to deliver tooling focused on cleaning and inspection of a marine riser section, comprising:
a. a motive assembly sized to fit within an interior of the marine riser section, the motive assembly controllable to selectively traverse the interior of the marine riser section; and
b. a predetermined set of attachments operatively connected to the motive assembly, the predetermined set of attachments useful for conducting a predetermined set of marine riser interior cleaning operations and a predetermined set of inspection operations while deployed within the marine riser section.

2. The robotic crawler useful to deliver tooling focused on cleaning and inspection of the marine riser sections of claim 1, wherein the motive assembly comprises:
a. a plurality of treads adapted to engage the interior of the marine riser section; and
b. a controllable motor operatively in communication with the plurality of treads.

3. The robotic crawler useful to deliver tooling focused on cleaning and inspection of the marine riser section of claim 1, wherein the motive assembly is operative to traverse the interior of the marine riser section where the marine riser section is in either a horizontal or a vertical orientation.

4. The robotic crawler useful to deliver tooling focused on cleaning and inspection of the marine riser section of claim 1, wherein the motive assembly comprises a selectively extendable and retractable portion configured to aid in allowing the motive assembly to engage the interior of the marine riser section.

5. The robotic crawler useful to deliver tooling focused on cleaning and inspection of the marine riser section of claim 1, wherein the predetermined set of operations comprise cleaning and inspection of the interior of the marine riser section.

6. The robotic crawler useful to deliver tooling focused on cleaning and inspection of the marine riser section of claim 1, wherein the predetermined set of attachments comprises a predetermined set of non-destructive testing equipment.

7. The robotic crawler useful to deliver tooling focused on cleaning and inspection of the marine riser section of claim 1, wherein the predetermined set of attachments comprises a water cleaning lance.

8. The robotic crawler useful to deliver tooling focused on cleaning and inspection of the marine riser section of claim 1, wherein the predetermined set of attachments comprises a high resolution camera.

9. A system for cleaning and inspection of an interior of a marine riser section, comprising:
a. a robotic crawler, comprising:
i. a motive assembly sized to fit within an interior of the marine riser section, the motive assembly controllable to selectively traverse the interior of the marine riser section; and
ii. a predetermined set of attachments operatively connected to the motive assembly, the predetermined set of attachments useful for conducting a predetermined set of marine riser section interior cleaning operations and inspection operations while deployed within the marine riser section;
b. a tether operatively connected to the robotic crawler at a first tether end and to a tether controller at a second tether end; and
c. an operation controller operatively in communication with the predetermined set of attachments.

10. A method for providing a system for the removal of an unwanted substance from a marine riser section prior to well completion, comprising:
a. inserting a system into the marine riser section, the system comprising a robotic crawler comprising a motive assembly sized to fit within an interior of the marine riser section, the motive assembly controllable to selectively traverse the interior of the marine riser section and a predetermined set of attachments operatively connected to the motive assembly, the predetermined set of attachments useful for conducting a predetermined set of marine riser section interior cleaning operations and inspection operations while deployed within the marine riser section;
b. using a first attachment of the predetermined set of attachments of the system to clean an interior of the marine riser section of an unwanted substance;
c. at a first predetermined time, using a second attachment of the predetermined set of attachments to perform a predetermined set of inspections of the interior of the marine riser section.

11. The method for providing a system for the removal of an unwanted substance from a marine riser section prior to well completion of claim 10, wherein the first predetermined time comprises a time substantially simultaneous with a time when the system is being used to clean the interior of the marine riser section.

12. The method for providing a system for the removal of an unwanted substance froth a marine riser section prior to well completion of claim 10, further comprising using the system to inspect a predetermined portion of the interior of the marine riser section using a visual inspection device to ensure that the cleaning was effective while the system is in the marine riser section.

13. The method for providing a system for the removal of an unwanted substance from a marine riser section prior to well completion of claim 12, wherein:
a. first predetermined time comprises a time after completion of cleaning; and
b. the predetermined set of inspections comprises using the system to conduct close visual inspection of the interior of the marine riser section, to record a wall thickness measurement of the interior of the marine riser section, to conduct a non-destructive test of a weld on a predetermined set of a marine riser section joint, to perform full length corrosion mapping and real time analysis in change detection, or to detect a corrosion hotspot in a surface coating.

14. The method for providing a system for the removal of an unwanted substance from a marine riser section prior to well completion of claim 13, wherein the nondestructive test comprises determining a thickness measurement on a main line to be conducted from the interior of the marine riser section due to a flotation collar on the exterior of about an outer portion of the marine riser section.

15. The method for providing a system for the removal of an unwanted substance from a marine riser section prior to well completion of claim 10, further comprising:
a. gathering data related to the marine riser section; and
b. cataloging the gathered data for use in viewing the data in a three dimensional model with an information overlay.

16. The method for providing a system for the removal of an unwanted substance from a marine riser section prior to well completion of claim 10, further comprising using a ToFT method to allow weld inspection through an entire heat affected zone.

17. The method for providing a system for the removal of an unwanted substance from a marine riser section prior to well completion of claim 10, further comprising conducting the inspection while the marine riser section is deployed in column connected to a blowout preventer (BOP).

18. The method for providing a system for the removal of an unwanted substance from a marine riser section prior to well completion of claim 17, further comprising conducting the inspection while the marine riser section contains seawater.
